(19) United States
(12) Patent Application Publication
(10) Pub. No.: US 2023/0068746 A1
(43) Pub. Date: Mar. 2, 2023

(54) FLAME RESISTANT MATERIAL HAVING TRACTION AND ENHANCED THERMAL PROPERTIES

(71) Applicant: Fire-Dex, LLC, Medina, OH (US)

(72) Inventor: Matthew L. Colatruglio, Medina, OH (US)

(21) Appl. No.: 17/929,196

(22) Filed: Sep. 1, 2022

Related U.S. Application Data
(60) Provisional application No. 63/239,442, filed on Sep. 1, 2021.

(51) Int. Cl. A41D 31/06; A41D 31/10

(52) U.S. Cl. CPC A41D 31/06; A41D 31/10

(57) ABSTRACT

A protective garment comprises a thermal liner, a moisture barrier, and an outer shell. A protective material is disposed on at least a portion of an exterior surface of the outer shell to enhance traction and thermal properties of the protective garment. In some embodiments, the protective material is disposed as one or more protuberances produced from a silicone material.

### CROSS-REFERENCE TO RELATED APPLICATION

This application claims the benefit of U.S. Provisional Patent Application Ser. No. 63/239,442, filed Sep. 1, 2021, the entirety of which is herein incorporated by reference.

### FIELD

The present disclosure relates to protective garments and, more specifically, to a protective garment using a flame resistant material having traction and enhanced thermal properties.

### BACKGROUND

Conventional firefighting turnout gear includes coats, pants, coveralls, helmets, gloves, footwear, and interface components. Typically, the coats and pants each comprises an outer shell, a moisture barrier located within the outer shell, and a thermal liner located within the moisture barrier. The outer shell typically is constructed of an abrasion-, flame- and heat-resistant material such as a woven aramid material, typically NOMEX® or KEVLAR®, (all are trademarks of E. I. DuPont de Nemours & Co., Inc.) or a polybenzamidazole such a PBI® (a trademark of Celanese Corp.) fiber material. The moisture barrier typically includes a semipermeable membrane layer which is moisture vapor permeable but impermeable to liquid moisture, such as CROSSTECH® (a trademark of W. L. Gore & Associates, Inc.) or STEDAIR® 4000 (a trademark of Stedfast Inc.). The membrane layer is bonded to a substrate of flame- and heat-resistant material, such as an aramid or PBI® material. Further, the thermal liner typically is constructed of a nonwoven fabric, usually spunlace, quilted to a facecloth.

It is often desirable to provide padding to the knee, elbow/forearm, and/or or shoulder areas of firefighting turnout gear to provide extra cushioning against compression or protection from heat for the firefighter's knees, elbows, forearms and/or shoulders and is also useful to absorb blows and other shocks that may be encountered in hazardous duty situations. Such cushioning is particularly useful when a firefighter is kneeling or crawling, or is carrying equipment such as a ladder, a hose, or breathing equipment (e.g. Self-Contained Breathing Apparatus (SCBA)), especially when entering a structure fire. The breathing equipment typically consists of a tank on the firefighters back held in place by shoulder straps. During firefighting activities it is possible that these straps could slide off a shoulder or slide into an uncomfortable position. In certain situations, a weight of a firefighter, or a weight of the equipment, is concentrated in a small area, which compresses the thermal liner in that area and thereby significantly reduces its insulating ability.

One of the most dangerous threats to firefighters is heat exhaustion, which could possibly result in death. Creating a more comfortable protective garment is key to protecting firefighters from becoming overheated. In areas such as the shoulder and upper back yoke, protective garment manufacturers typically add multiple layers of fabric or pads to add protection, which includes the need to pass the conductive and compressive heat resistance test as specified in National Fire Protection Association (NFPA) 1971 standard, incorporated herein by reference. Adding multiple layers of fabric and/or pads reduces the comfort of the garment due to its insulative nature.

A problem with adding the pads for use with firefighting garments is that they provide relatively little additional thermal protection to the knees, elbow, and/or shoulder portions of the garment when compressed. Accordingly, such conventional knee-, elbow-, and/or shoulder pads do little to prevent burns in the knees, elbows, and/or shoulders of firefighters resulting from the loss of insulating ability caused by compression of the protective garment in those areas. Drawbacks for those conventional pads and the multiple layers of fabric that do provide additional thermal protection are that they increase a weight (i.e., a bulk) of the protective garment, and may also trap heat therewithin, which may lead to heat exhaustion of a wearer. Additionally, there exists a problem of such thermal protection breaking down over time due to damage, compression and/or abrasions. Conventional pads can become deformed after time losing thickness and shape and providing less protection. A further problem with conventional pads is their tendency to absorb water or otherwise retain substantial quantities of water. Saturated pads, when exposed to thermal energy conduct that heat at far greater rates than insulation which does not store water.

Accordingly, it would be desirable to provide a protective garment using a flame resistant material having traction and enhanced thermal properties.

### SUMMARY

In concordance and agreement with the presently described subject matter, a protective garment using a flame resistant material having traction and enhanced thermal properties, has surprisingly been discovered.

In one embodiment, a protective garment, comprises: an outer shell; and a protective material disposed on at least a portion of the outer shell, wherein the protective material increases a traction and/or a thermal property of the protective garment.

As aspects of some embodiments, the protective material is a silicone material.

As aspects of some embodiments, the protective material is disposed on at least one of an elbow area, a back of a sleeve area, a knee area, an upper back area, and a shoulder area of the protective garment.

As aspects of some embodiments, the protective material is disposed as one or more protuberances on at least a portion of an exterior surface of the outer shell.

As aspects of some embodiments, the outer shell is produced from at least one of an aramid material, a polybenzamidazole material, a polybenzoxazole material, and an oxidized polyacrylonitrile (OPAN) material.

As aspects of some embodiments, the protective garment further comprises at least one of a thermal liner and a moisture barrier.

As aspects of some embodiments, the moisture barrier is disposed between the outer shell and the thermal liner.

As aspects of some embodiments, the thermal liner comprises a facecloth layer and a first insulation layer.

As aspects of some embodiments, the facecloth layer is produced from at least one aramid material.

As aspects of some embodiments, the first insulation layer is produced from at least one of a spunlace.

As aspects of some embodiments, the thermal liner further comprises a second insulation layer.

As aspects of some embodiments, the second insulation layer is produced from a spunlace.

As aspects of some embodiments, the outer shell is an exterior portion of a firefighter turnout gear.

In another embodiment, a method of producing a protective garment, comprises the steps of: providing an outer shell; and disposing a protective material on at least a portion of the outer shell, wherein the protective material increases a traction and/or a thermal property of the protective garment.

As aspects of some embodiments, the protective material is a silicone material.

As aspects of some embodiments, the protective material is disposed on at least one of an elbow area, a back of a sleeve area, a knee area, an upper back area, and a shoulder area of the protective garment.

As aspects of some embodiments, the protective material is disposed as one or more protuberances on at least a portion of an exterior surface of the outer shell.

As aspects of some embodiments, the outer shell is produced from at least one of an aramid material, a polybenzamidazole material, a polybenzoxazole material, and an oxidized polyacrylonitrile (OPAN) material.

As aspects of some embodiments, the method further comprises at least one of a thermal liner and a moisture barrier.

As aspects of some embodiments, the moisture barrier is disposed between the outer shell and the thermal liner.

### BRIEF DESCRIPTION OF THE DRAWINGS

The above, as well as other advantages of the present disclosure, will become readily apparent to those skilled in the art from the following detailed description of a preferred embodiment when considered in the light of the accompanying drawings.

FIG. 1 is a fragmentary rear perspective view of a protective garment including at least one augmented portion according to an embodiment of the present disclosure;

FIG. 2 is an enlarged view of the at least one augmented portion of FIG. 1; and

FIG. 3 is a cross-sectional view of the augmented portion taken along section line A-A of FIG. 2.

### DETAILED DESCRIPTION

The following detailed description and appended drawings describe and illustrate various exemplary embodiments of the present disclosure. The description and drawings serve to enable one skilled in the art to make and use the present disclosure, and are not intended to limit the scope of the present disclosure in any manner. In respect of the methods disclosed, the steps presented are exemplary in nature, and thus, the order of the steps is not necessary or critical.

The present disclosure utilizes a flame resistant protective material, certified to the NFPA 1971 standards having enhanced traction/grip and thermal properties such as enhanced conductive and compressive heat resistance and thermal protection performance. Such protective material can be used in various areas of protective garments, such as elbows, knees, and/or shoulders, for example. In some instances, the protective material provides traction/grip so that equipment or other articles being carried by the wearer will stay in place and not slip off of the wearer. It can also be used on various areas of firefighter turnout gear to provide improved thermal protection as measured by the compressive and conductive heat resistance (CCHR) test of the NFPA 1971 standards. Conventional firefighter turnout gear requires five or more layers to pass the CCHR test. For example, the conventional firefighter turnout gear includes an outer shell, a first moisture barrier, a first thermal liner, a second moisture barrier, and a second thermal liner. The present disclosure utilizes the protective material having enhanced traction/grip and thermal properties to reduce an amount of layers required for the protective garments, and more particularly to be compliant with the NFPA 1971 standards.

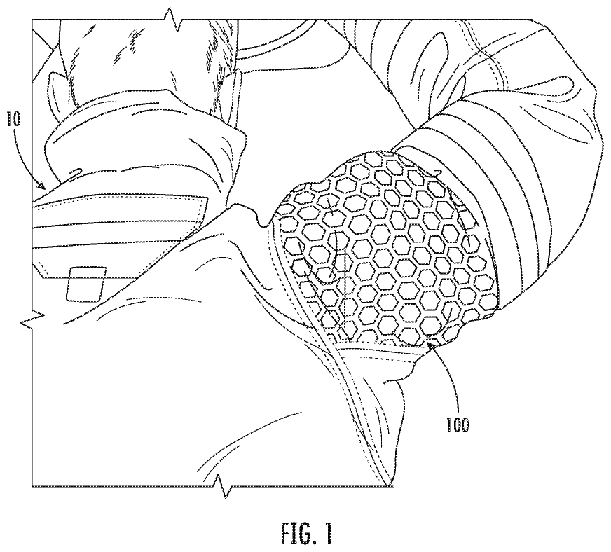

FIG. 1 illustrates an example protective garment 10. More particularly, FIG. 1 illustrates a firefighter turnout coat that can be donned by firefighter personnel when exposed to flames and extreme heat. It is noted that, although a firefighter turnout coat is shown in the figure and described herein, the present disclosure pertains to protective garments generally. Accordingly, the identification of firefighter turnout gear is not intended to limit the scope of the disclosure. The protective garment 10 may be other types of protective garments which include, but are not limited to, suits for industrial workers (including, for example, arc flash apparel), wildland's firefighters, race car drivers, airplane pilots, military personnel, and the like.

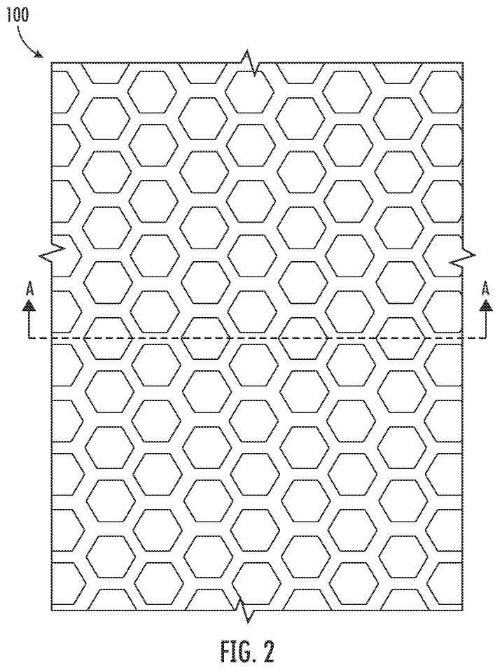

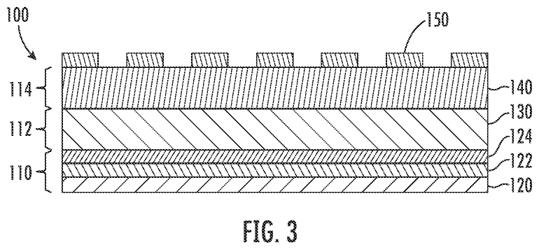

As depicted, the protective garment 10 includes at least one augmented portion 100. An enlarged view of a surface of the augmented portion 100 is shown in FIG. 2. In certain embodiments, the augmented portion 100 may have a multi-layer construction. As best seen in FIG. 3, the augmented portion 100 generally comprises a thermal liner 110 that forms an interior surface (i.e., a surface that contacts the wearer) of the protective garment 10, a moisture barrier 112 that forms an intermediate layer of the protective garment 10, and an outer shell 114 that forms an exterior surface of the protective garment 10. When integrated the thermal liner 110, the moisture barrier 112, and the outer shell 114 may be characterized as having a thermal protective performance (TPP per NFPA 1971) of at least 35.

The thermal liner 110 shown may, optionally, include a facecloth layer 120, a first insulation layer 122, and a second insulation layer 124, which may be quilted together. In alternative embodiments, however, the thermal liner 110 may only include one of the insulation layers 122, 124 used with or without the facecloth layer 120. When it is used, the facecloth layer 120 may be constructed of woven material comprising flame resistant and/or moisture-wicking fibers or filaments made of, for example, aramid (meta-aramid or para-aramid), polybenzimidazole, polybenzoxazole, melamine, cellulosics, flame resistant (FR) cellulosics, modacrylic, carbon, or the like, and blends thereof. The facecloth layer 120 may be, optionally, finished with a hydrophilic finish that draws perspiration off of the wearer, if desired.

Each of the insulation layer 122, 124 may comprise a nonwoven material that includes one or more flame resistant fibers. The insulation layers 122, 124 may each comprise a single layer of nonwoven, or two layers of nonwoven, or multiple layers of nonwoven. In one embodiment, the nonwoven may be spunlace. More preferably, the first insulation layer 122 may be produced from a blend of meta-aramid (e.g., Nomex™) and/or para-aramid (e.g., KevlarTM) spunlace and/or the second insulation layer 123 may be a fleece material produced from a blend of meta-aramid (e.g., Nomex™), para-aramid (e.g., KevlarTM), and/or anti-static fibers. In one embodiment, the flame resistant fibers may also be characterized as non-water absorbing fibers. Non-water absorbing fiber does not refer to the moisture regain of the fiber. Moisture regain, as used herein, refers to percentage of atmospheric moisture in a textile material brought into equilibrium with a standard atmosphere after partial drying, calculated as a percentage of the moisture-free weight. Instead, non-water absorbing fiber refers to the fibers ability, when placed in contact with liquid water, to swell, absorb, and retain that water.

It is understood that the facecloth layer 120 and/or the insulation layers 122, 124, collectively the thermal liner 110, may have any suitable thickness as desired.

The moisture barrier 112 may be constructed of a non-woven or woven flame resistant fabric 130 comprising flame resistant fibers made of, for example, aramid (meta-and/or para-aramid), polybenzimidazole, polybenzoxazole, melamine, or the like, and blends thereof The moisture barrier 112 may be laminated with a water-impermeable layer of material (not depicted) such as, for instance, a layer of polytetrafluoroethylene (PTFE), expanded polytetrafluoroethylene (ePTFE), polyurethane (PU), urethane, and the like, or any combination thereof When such an impermeable layer is provided, it usually is provided on the moisture barrier 112, so as to face the thermal liner 110. It is understood that the moisture barrier 112 may have any suitable thickness as desired.

The outer shell 114 is typically constructed of a heat and flame resistant material 140 that comprises flame resistant fibers made of, for example, at least one of aramid (meta- and/or para-aramid), polybenzamidazole, polybenzoxazole, oxidized polyacrylonitrile (OPAN), or the like, and blends thereof. The outer shell 114 may be treated with a water-resistant finish to prevent or reduce water absorption from the outside environment. In that the outer shell 114 forms an exterior surface of the protective garment 10, the outer shell 114 preferably is constructed so as to be flame resistant to protect the wearer against being burned in certain applications. In addition, the outer shell 114 preferably is strong so as to be resistant to tearing and abrasion during use in extreme environments. As identified above, the traction/grip properties as well as compressive and conductive heat resistance and thermal protection properties of the outer shell 114 may be enhanced by providing a protective material 150 on the exterior surface of the outer shell 114. In certain embodiments, the protective material 150 may be a silicone material. As shown in FIG. 1, the protective material 150 may be discretely-positioned and used in predetermined areas (e.g. elbow, back of sleeve, knee, upper back, and shoulder areas of the protective garment 10). Therefore, the protective garment 10 may be significantly improved without sacrificing pliability, processibility, and the like. By using the protective material 150, it is possible to eliminate multiple layers of material/fabric used in traditional protective garments, and produce a protective garment 10 that only comprises the thermal liner 110, moisture barrier 112, and outer shell 114.

In some instances, one or more protuberances of the protective material 150 may be disposed on the exterior surface of the outer shell 114 in any thickness, size, shape, number, and configuration. In a non-limiting example depicted in FIG. 2, the protuberances are equidistantly spaced apart from one another, each having a generally hexagonal shape. In other instances, the protective material 150 may be disposed as a continuous layer covering an entirety of the predetermined area. The thickness, size, shape, number, and configuration of the protective material 150 may vary depending on an application of the protective garment 10 and the desired traction/grip, compressive and conductive heat resistance, and/or thermal protection properties thereof. For example, the protective material 150 may be generally uniform with a relatively small amount of space between each of the protuberances and the thickness thereof may be about 300 microns when disposed on the outer shell 114 of firefighter turnout gear. Various methods may be employed to dispose the protective material 150 on the exterior surface of the outer shell 114 such as a printing process, for example.

In another embodiment, the protective material 150 may be used as a replacement for the insulation layers 122, 124 of the thermal liner 110. Accordingly, the protective material 150 may be disposed directly on the facecloth layer 120 eliminating the insulation layers 122, 123. As such, a weight of the thermal liner 110 would be decreased, resulting in a more comfortable protective garment 10.

Advantageously, the protective garment 10 having the protective material 150 provides improved comfort (fewer layers) and thermal protection, while maintaining a position of the equipment (e.g. SCBA straps in place on the shoulder), through traction/grip, so that the equipment is in the correct operating position at all times allowing the wearer to work more effectively and efficiently. The protective garment 10 of the present disclosure is compliant with any and all associated NFPA standards.

From the foregoing description, one ordinarily skilled in the art can easily ascertain the essential characteristics of this present disclosure and, without departing from the spirit and scope thereof, can make various changes and modifications to the present disclosure to adapt it to various usages and conditions.

What is claimed is:

1. A protective garment, comprising:
an outer shell; and
a protective material disposed on at least a portion of the outer shell, wherein the protective material increases a traction and/or a thermal property of the protective garment.

2. The protective garment of claim 1, wherein the protective material is a silicone material.

3. The protective garment of claim 1, wherein the protective material is disposed on at least one of an elbow area, a back of a sleeve area, a knee area, an upper back area, and a shoulder area of the protective garment.

4. The protective garment of claim 1, wherein the protective material is disposed as one or more protuberances on at least a portion of an exterior surface of the outer shell.

5. The protective garment of claim 1, wherein the outer shell is produced from at least one of an aramid material, a polybenzamidazole material, a polybenzoxazole material, and an oxidized polyacrylonitrile (OPAN) material.

6. The protective garment of claim 1, further comprising at least one of a thermal liner and a moisture barrier.

7. The protective garment of claim 6, wherein the moisture barrier is disposed between the outer shell and the thermal liner.

8. The protective garment of claim 1, wherein the thermal liner comprises a facecloth layer and a first insulation layer.

9. The protective garment of claim 8, wherein the facecloth layer is produced from at least one aramid material.

10. The protective garment of claim 8, wherein the first insulation layer is produced from a spunlace.

11. The protective garment of claim 8, wherein the thermal liner further comprises a second insulation layer.

12. The protective garment of claim 11, wherein the second insulation layer is produced from a spunlace.

13. The protective garment of claim 1, wherein the outer shell is an exterior portion of a firefighter turnout gear.

14. A method of producing a protective garment, comprising the steps of:
providing an outer shell; and
disposing a protective material on at least a portion of the outer shell, wherein the protective material increases a traction and/or a thermal property of the protective garment.

15. The method of claim 14, wherein the protective material is a silicone material.

16. The method of claim 14, wherein the protective material is disposed on at least one of an elbow area, a back of a sleeve area, a knee area, an upper back area, and a shoulder area of the protective garment.

17. The method of claim 14, wherein the protective material is disposed as one or more protuberances on at least a portion of an exterior surface of the outer shell.

18. The method of claim 14, wherein the outer shell is produced from at least one of an aramid material, a polybenzamidazole material, a polybenzoxazole material, and an oxidized polyacrylonitrile (OPAN) material.

19. The method of claim 14, further comprising at least one of a thermal liner and a moisture barrier.

20. The method of claim 19, wherein the moisture barrier is disposed between the outer shell and the thermal liner.
